(19) United States
(12) Patent Application Publication
(10) Pub. No.: US 2023/0011102 A1
(43) Pub. Date: Jan. 12, 2023

(54) SYSTEMS AND METHODS FOR COLLABORATIVE FILTERING-BASED AUDIT TEST SCOPING

(71) Applicant: JPMORGAN CHASE BANK, N.A., New York, NY (US)

(72) Inventors: Raghuram SRINIVAS, Frisco, TX (US); Mohammed K. OSMAN, Norman, OK (US); Michael PERROTTE, Dallas, TX (US); Subhashini TRIPURANENI, Flower Mound, TX (US)

(21) Appl. No.: 17/373,260

(22) Filed: Jul. 12, 2021

(51) Int. Cl. G06Q 10/06

(52) U.S. Cl. CPC G06Q 10/06395; G06Q 10/0635; G06Q 10/06315

(57) ABSTRACT

Systems and methods for collaborative filtering-based audit test scoping are disclosed. In one embodiment, a method for collaborative filtering-based audit test scoping may include: (1) receiving, by a proactive audit computer program, an identification of a Process Audit Universe Items (PAUI) of interest; (2) retrieving, by the proactive audit computer program, historical audit data for a plurality of PAUIs; (3) implicitly grouping, by the proactive audit computer program, the plurality of PAUIs into a plurality of implicit PAUI groupings; (4) applying, by the proactive audit computer program, natural language processing to the PAUI of interest to identify a similar implicit PAUI grouping; (5) ranking, by the proactive audit computer program, risks and controls for the similar implicit PAUI groupings; and (6) outputting, by the proactive audit computer program, the ranked risks and controls for the similar implicit PAUI groupings.

### BACKGROUND OF THE INVENTION

### 1. Field of the Invention

Embodiments relate generally to systems and methods for collaborative filtering-based audit test scoping.

### 2. Description of the Related Art

Organizations are often audited across various parts of the organization, such as by Process Audit Universe Items, or PAUIs, for various kinds of risks and control failures. The organizations are evaluated for the risks and controls established to ensure compliance with new and existing policies, procedures, laws, and regulations, any of which could have a significant impact on the organization.

PAUIs are assessed for their risks and assigned a risk level. Based on risk levels, audit exercises may be launched. The audit exercise involves identifying specific risk functions and controls to be audited and developing test scripts. Accurate scoping of tests is key to ensuring proactive identification and resolution of issues that may cause financial and reputational risks to the organization.

### SUMMARY OF THE INVENTION

Systems and methods for collaborative filtering-based audit test scoping are disclosed. In one embodiment, a method for collaborative filtering-based audit test scoping may include: (1) receiving, by a proactive audit computer program, an identification of a Process Audit Universe Items (PAUI) of interest; (2) retrieving, by the proactive audit computer program, historical audit data for a plurality of PAUIs; (3) implicitly grouping, by the proactive audit computer program, the plurality of PAUIs into a plurality of implicit PAUI groupings; (4) applying, by the proactive audit computer program, natural language processing to the PAUI of interest to identify a similar implicit PAUI grouping; (5) ranking, by the proactive audit computer program, risks and controls for the similar implicit PAUI groupings; and (6) outputting, by the proactive audit computer program, the ranked risks and controls for the similar implicit PAUI groupings.

In one embodiment, the identification of the PAUI may be received at a user interface, from a computer program, etc.

In one embodiment, the historical audit data may include risks and controls applied to the plurality of PAUIs and results of the risks and controls applied.

In one embodiment, the plurality of PAUIs may be implicitly groped into a plurality of implicit PAUI groupings based on overlaps in the historical audit data.

In one embodiment, an input to a collaborative filtering model may be a matrix comprising a row for each of the plurality of PAUIs in the implicit PAUI grouping and a column for each risk and control.

In one embodiment, the proactive audit computer program may identify the similar implicit PAUI grouping based on similarities in process descriptions, risk assessment information, business applications supported, and/or regulatory requirements for the PAUI of interest and the implicit PAUI groupings.

In one embodiment, the risks and controls may be ranked based on severity.

In one embodiment, the output of ranked risks and controls may include a basis for including each of the risks and controls.

According to another embodiment, an electronic device may include a memory storing a proactive audit computer program and a computer processor. The proactive audit computer program, when executed by the computer processor, may cause the computer processor to: receive an identification of a Process Audit Universe Items (PAUI) of interest; retrieve historical audit data for a plurality of PAUIs; implicitly group the plurality of PAUIs into a plurality of implicit PAUI groupings; apply natural language processing to the PAUI of interest to identify a similar implicit PAUI grouping; rank risks and controls for the similar implicit PAUI groupings; and output the ranked risks and controls for the similar implicit PAUI groupings.

In one embodiment, the identification of the PAUI may be received at a user interface, from a computer program, etc.

In one embodiment, the historical audit data may include risks and controls applied to the plurality of PAUIs and results of the risks and controls applied.

In one embodiment, the plurality of PAUIs may be implicitly groped into a plurality of implicit PAUI groupings based on overlaps in the historical audit data.

In one embodiment, an input to a collaborative filtering model may be a matrix comprising a row for each of the plurality of PAUIs in the implicit PAUI grouping and a column for each risk and control.

In one embodiment, the proactive audit computer program may identify the similar implicit PAUI grouping based on similarities in process descriptions, risk assessment information, business applications supported, and/or regulatory requirements for the PAUI of interest and the implicit PAUI groupings.

In one embodiment, the risks and controls may be ranked based on severity.

In one embodiment, the output of ranked risks and controls may include a basis for including each of the risks and controls.

According to another embodiment a system may include an electronic device a computer processor, a database comprising historical audit data, and a user interface. The electronic device may be configured to: receive, from the user interface, an identification of a Process Audit Universe Items (PAUI) of interest; retrieve historical audit data for a plurality of PAUIs, wherein the historical audit data may include risks and controls applied to the plurality of PAUIs and results of the risks and controls applied; implicitly group the plurality of PAUIs into a plurality of implicit PAUI groupings, wherein the plurality of PAUIs are implicitly groped into a plurality of implicit PAUI groupings based on overlaps in the historical audit data; apply natural language processing to the PAUI of interest to identify a similar implicit PAUI grouping, wherein the similar implicit PAUI grouping are identified based on similarities in process descriptions, risk assessment information, business applications supported, and/or regulatory requirements for the PAUI of interest and the implicit PAUI groupings; rank risks and controls for the similar implicit PAUI groupings, wherein the risks and controls are ranked based on severity; and output, to the user interface, the ranked risks and controls for the similar implicit PAUI groupings, wherein the risks and controls are ranked based on severity.

In one embodiment, an input to a collaborative filtering model may be a matrix comprising a row for each of the plurality of PAUIs in the implicit PAUI grouping and a column for each risk and control.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for collaborative filtering-based audit test scoping according to one embodiment; and

FIG. 2 depicts a method for collaborative filtering-based audit test scoping according to an embodiment.

### DETAILED DESCRIPTION OF PREFERRED EMBODIMENTS

Embodiments relate generally to systems and methods for collaborative filtering-based audit test scoping.

To reduce operational risk and optimize testing coverage, embodiments may use Natural Language Processing (NLP) and/or Machine Learning (ML) to identity new risk and control combinations, along with test steps, for all PAUIs.

Embodiments may identity the PAUIs that are likely to fail when audited next, including the risks, the controls that may fail, etc.

Embodiments may provide the following: a recommendation engine to recommend curated themes based on outcomes from NLP based topic modeling, and the application of collaborative filtering to scope audit testing exercises.

Further generalizable as application of collaborative filtering in the domain of Quality Assurance across several related entities are periodically tested. The entities tested could be business functions, products (technology products or manufactured products).

Embodiments may provide audit recommendations for PAUIs based on a risk assessment, an PAUI Description, and any other characteristics as is necessary and or desired to recommend new risk and control combinations that can be tested. In one embodiment, historical audit data may be used to provide recommendations.

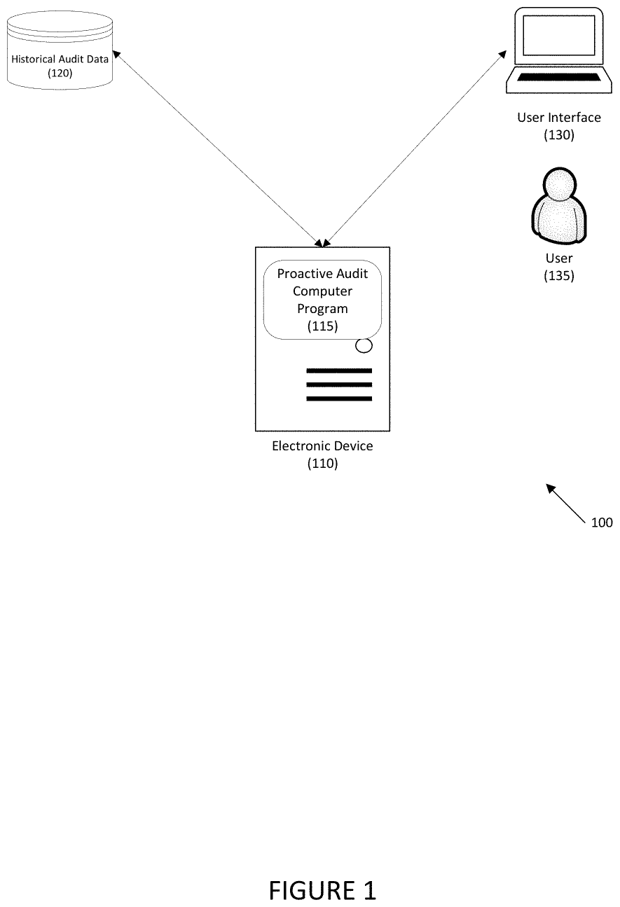

Referring to FIG. 1, a system for collaborative filtering-based audit test scoping is disclosed according to an embodiment. System 100 may include electronic device 110, which may be any suitable electronic device, including servers (e.g., cloud-based, physical, combinations). Electronic device 110 may execute proactive audit computer program 115 that may perform collaborative filtering to scope audit testing exercises.

Proactive audit computer program 115 may interface with one or more database 120 that may store historical audit data, including risks and controls.

In one embodiment, proactive audit computer program 115 may include a machine learning component that may review historical audit data 120 and may create intelligence from the data, such as recommendations from the data. This curated intelligence may be made available and ready for the end user.

In one embodiment, proactive audit computer program 115 may identify PAUIs that have common features as an PAUI and may group multiple PAUIs into profile groups. Based on the similarities between the PAUIs and the those in the profile groups, such as in risk assessment, PAUI description, etc., proactive audit computer program 115 may recommend new risks and controls to be tested and/or implemented with the PAUI in question. In one embodiment, proactive audit computer program 115 may rank the risks and controls by issue severity, such as severe, moderate, and low. Any suitable manner of ranking the risk severity may be used as is necessary and/or desired.

In one embodiment, user 135 may access proactive audit computer program 115 using user interface 130, which may be executed on any suitable electronic device (e.g., computer, smartphone, Internet of Things device, etc.). In one embodiment, proactive audit computer program 115 may be accessed by a browser, a computer program, etc.

In one embodiment, proactive audit computer program 115 may be executed on same electronic device 110 on which user interface 130 is provided.

At the time of audit planning, user 135 may select a PAUI for audit planning Proactive audit computer program 115 query the curated intelligence and may present the appropriate and/or related risks and controls are to the end user.

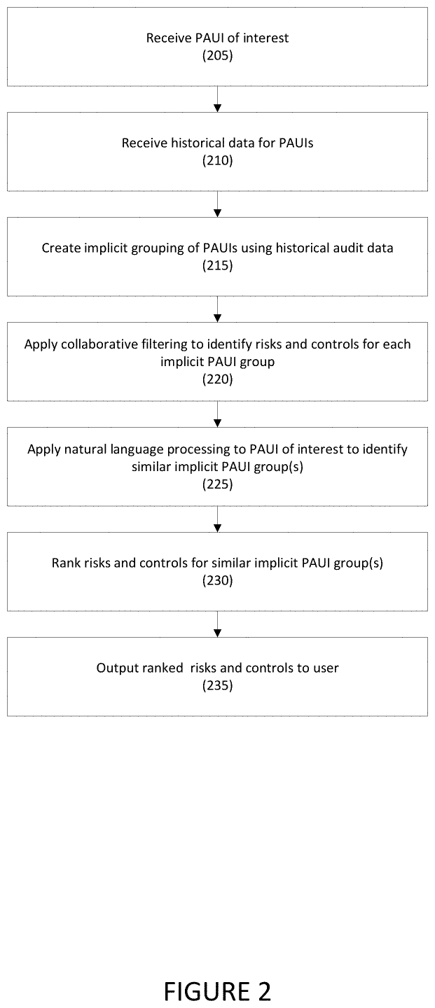

Referring to FIG. 2, a method for collaborative filtering-based audit test scoping is disclosed according to an embodiment.

In step 205, a PAUI of interest may be identified. In one embodiment, the PAUI of interest may be identified by a user via a user interface. In another embodiment, the PAUI of interest may be identified by a program, such as a proactive audit computer program.

In step 210, the proactive audit computer program may retrieve historical audit data for the PAUIs in an organization. Examples may include risks and controls applied to the PAUIs and the results of the application. In one embodiment, the historical audit data may be retrieved from one or more databases, including internal and external databases. In one embodiment, the historical audit data may identify risk and controls applied to mitigate the risks.

In step 215, the proactive audit computer program may group the PAUIs based on the historical audit data. The intuition is that if two PAUIs were independently tested for similar processes (e.g., loan statements accuracy and truth in lending processes), it is likely there may be other similar areas where these two PAUIs will have overlap. Examples of implicit grouping are provided in Srinivas, R., Klimovich, P. V. & Larson, E. C. “Implicit-descriptor ligand-based virtual screening by means of collaborative filtering” Journal of Chemical Information and Modeling 10, 56 (2018) and Raghuram Srinivas, Niraj Verma, Elfi Kraka, and Eric C. Larson “Deep Learning-Based Ligand Design Using Shared Latent Implicit Fingerprints from Collaborative Filtering” Journal of Chemical Information and Modeling 61 (5), 2159-2174 (2021), the disclosures of which are hereby incorporated, by reference, in their entireties.

In step 220, the proactive audit computer program may apply a machine learning model to the implicit PAUI groupings. For example, collaborative filtering may identity and recommend new risks and controls that can be tested. The collaborative filtering model may be trained on all historical instances of PAUIs and the historical audit data (e.g., risks and controls tested and outcomes). In one embodiment, the model input is a matrix of PAUIs (rows) and risks and controls (columns), with issue severity being the value in the cells.

For example, using a sparse matrix as a starting point, collaborative filtering may be applied to the matrix, resulting in a filled matrix with the latent common attributes between PAUIs enabling the completion of sparse matrix.

In step 225, the proactive audit computer program may apply natural language processing or a similar technique to the PAUI of interest to identify similar implicit PAUI group(s) based on, for example, process description, risk assessment information, business applications supported and regulatory requirements. In one embodiment, a proactive audit computer program may identify other PAUIs that may have common features with the PAUI of interest using, for example, descriptions of the PAUI of interest to identify similar PAUIs.

For example, the PAUI of interest may be a mortgage loan, and, based on the similarity in their descriptions, a similar PAUI may be an auto loan.

In step 230, the proactive audit computer program may identify the risks and controls for each similar implicit PAUI grouping, and may rank the risks and controls based on, for example, severity of impact to the PAUI of interest. For example, the proactive audit computer program may rank the risks and controls using severe, moderate, and low assessments. Any other manner of ranking the risks and controls may be used as is necessary and/or desired.

In step 235, the proactive audit computer program may output the risk and control recommendations to the user. In one embodiment, the risks and controls may be presented by PAUI, and may be filtered (e.g., only risks and controls pertaining to a certain issue type may be provided, only the severe impact risks and controls are output, only the top 10 ranked risks and controls are output, etc.).

In one embodiment, the collaborative filtering algorithm may rank the PAUIs based on severity. The PAUIs may also be ranked based on similarity to the explicit grouping for the PAUI.

In one embodiment, the output may identify the reason(s) for the risks and controls that are output. For example, for the implicit grouping, the overlapping tests and outcomes may be identified. For the explicit grouping, the overlapping descriptions, functions, processes, etc. may be identified.

In one embodiment, the recommended risks and controls may be scoped for new audit activity after review by relevant auditors.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for collaborative filtering-based audit test scoping, comprising:
receiving, by a proactive audit computer program, an identification of a Process Audit Universe Item (PAUI) of interest;
retrieving, by the proactive audit computer program, historical audit data for a plurality of PAUIs;
implicitly grouping, by the proactive audit computer program, the plurality of PAUIs into a plurality of implicit PAUI groupings;
applying, by the proactive audit computer program, natural language processing to the PAUI of interest to identify at least one of the plurality of implicit PAUI groupings that is similar to the PAUI of interest;
ranking, by the proactive audit computer program, risks and controls for the similar implicit PAUI groupings; and
outputting, by the proactive audit computer program, ranked risks and controls for the PAUI of interest based on the ranked risks and controls for the similar implicit PAUI groupings.

2. The method of claim 1, wherein the identification of the PAUI is received at a user interface.

3. The method of claim 1, wherein the identification of the PAUI is received from a computer program.

4. The method of claim 1, wherein the historical audit data comprises risks and controls applied to the plurality of PAUIs and results of the risks and controls applied.

5. The method of claim 1, wherein the plurality of PAUIs are implicitly grouped into a plurality of implicit PAUI groupings based on overlaps in the historical audit data.

6. The method of claim 1, wherein an input to a collaborative filtering model is a matrix comprising a row for each of the plurality of PAUIs in the implicit PAUI grouping and a column for each risk and control.

7. The method of claim 1, wherein the proactive audit computer program identifies the similar implicit PAUI grouping based on similarities in process descriptions, risk assessment information, business applications supported, and/or regulatory requirements for the PAUI of interest and the implicit PAUI groupings.

8. The method of claim 1, wherein the risks and controls are ranked based on severity.

9. The method of claim 1, wherein the output of ranked risks and controls comprises a basis for including each of the risks and controls.

10. An electronic device, comprising:
a memory storing a proactive audit computer program; and
a computer processor;
wherein the proactive audit computer program, when executed by the computer processor, causes the computer processor to:
receive an identification of a Process Audit Universe Item (PAUI) of interest;
retrieve historical audit data for a plurality of PAUIs;
implicitly group the plurality of PAUIs into a plurality of implicit PAUI groupings;
apply natural language processing to the PAUI of interest to identify implicit PAUI groupings of the plurality of implicit PAUI groupings that are similar to the PAUI of interest;
rank risks and controls for the similar implicit PAUI groupings; and
output ranked risks and controls for the PAUI of interest based on the ranked risks and controls for the similar implicit PAUI groupings.

11. The electronic device of claim 10, wherein the identification of the PAUI is received at a user interface.

12. The electronic device of claim 10, wherein the identification of the PAUI is received from a computer program.

13. The electronic device of claim 10, wherein the historical audit data comprises risks and controls applied to the plurality of PAUIs and results of the risks and controls applied.

14. The electronic device of claim 10, wherein the plurality of PAUIs are implicitly grouped into a plurality of implicit PAUI groupings based on overlaps in the historical audit data.

15. The electronic device of claim 10, wherein an input to a collaborative filtering model is a matrix comprising a row for each of the plurality of PAUIs in the implicit PAUI grouping and a column for each risk and control.

16. The electronic device of claim 10, wherein the proactive audit computer program identifies the similar implicit PAUI grouping based on similarities in process descriptions, risk assessment information, business applications supported, and/or regulatory requirements for the PAUI of interest and the implicit PAUI groupings.

17. The electronic device of claim 10, wherein the risks and controls are ranked based on severity.

18. The electronic device of claim 10, wherein the output of ranked risks and controls comprises a basis for including each of the risks and controls.

19. A system, comprising:
an electronic device;
a computer processor;
a database comprising historical audit data; and
a user interface;
wherein the electronic device is configured to:
receive, from the user interface, an identification of a Process Audit Universe Item (PAUI) of interest;
retrieve historical audit data for a plurality of PAUIs, wherein the historical audit data comprises risks and controls applied to the plurality of PAUIs and results of the risks and controls applied;
implicitly group the plurality of PAUIs into a plurality of implicit PAUI groupings, wherein the plurality of PAUIs are implicitly grouped into a plurality of implicit PAUI groupings based on overlaps in the historical audit data;
apply natural language processing to the PAUI of interest to identify implicit PAUI groupings of the plurality of implicit PAUI groupings that are similar to the PAUI of interest, wherein the similar implicit PAUI groupings are identified based on similarities in process descriptions, risk assessment information, business applications supported, and/or regulatory requirements for the PAUI of interest and the implicit PAUI groupings;
rank risks and controls for the similar implicit PAUI groupings, wherein the risks and controls are ranked based on severity; and
output, to the user interface, ranked risks and controls for the PAUI of interest based on the ranked risks and controls for the similar implicit PAUI groupings, wherein the risks and controls are ranked based on severity.

20. The system of claim 19, wherein an input to a collaborative filtering model is a matrix comprising a row for each of the plurality of PAUIs in the implicit PAUI grouping and a column for each risk and control.
